(19) United States
(12) Patent Application Publication
(10) Pub. No.: US 2015/0379125 A1
(43) Pub. Date: Dec. 31, 2015

(54) NETWORK CAMERA DATA MANAGEMENT SYSTEM AND MANAGING METHOD THEREOF

(71) Applicant: AMARYLLO INTERNATIONAL, INC., Hsinchu County (TW)

(72) Inventors: CHAO-TUNG YANG, Hsinchu County (TW); KUANG-JUI CHENG, Hsinchu County (TW); WEN-KUANG LIN, Hsinchu County (TW)

(21) Appl. No.: 14/523,326

(22) Filed: Oct. 24, 2014

(30) Foreign Application Priority Data
Jun. 26, 2014 (TW) 103122180

(51) Int. Cl. G06F 17/30; H04N 5/232; H04N 1/21

(52) U.S. Cl. CPC G06F 17/30817; H04N 1/2187; H04N 5/23206

(57) ABSTRACT

Disclosed is a network camera data management system for managing camera data of a network camera, including: a data importing device, a segmenting and storing device, and a data capture device. A management method utilized by the network camera data management system includes the steps of: segmenting the imported camera data into a plurality of time segmented data items based on time intervals; storing the plurality of time segmented data items respectively in a plurality of servers and/or in a plurality of server storage areas having non-sequential storage addresses with each other; and capturing, according to a search condition, a corresponding time segmented data item and/or a fragment of the corresponding time segmented data item of the from the plurality of time segmented data items stored.

### FIELD OF THE INVENTION

The present invention relates to a network camera, and more particularly to a network camera data management system and a management method thereof.

### BACKGROUND OF THE INVENTION

With the development of network technology, network cameras have become increasingly popular and been widely used in security surveillance, home care and the like. A user is able to view camera data on his/her personal computer or smart phone in real time by connecting a network camera to a network at home, office, or even outdoors.

In addition to a real-time viewing function, some network cameras are also provided with a function of transmitting and storing camera data online, that is, the camera data can be uploaded to a storage space of a server provided by a person or a business and stored therein, thereby enabling a user to retrieve, view and edit the uploaded data in the future.

However, it usually operates a long time for a network camera to record camera data for security surveillance, home care or for a variety of other purposes. Hence, the time duration and the size of camera data obtained is considerable. In such a case, a user is inevitable to a need to prepare an enormous storage space to store the huge-sized camera data. It also causes difficult for a system to fully support the processes of retrieving, viewing and editing data. Consequently, the system's overall performance of execution is deteriorated, resulting in such issues as low processing speed and poor quality.

### SUMMARY OF THE INVENTION

In view of the above, conventional technology still has some disadvantages in storing, retrieving, viewing and editing camera data, which consequently result in such issues as low processing speed and poor quality.

Accordingly, an object of the present invention is to provide a network camera data management system and a management method thereof for managing camera data of a network camera more efficiently.

The present invention provides a network camera data management system for managing camera data, comprising: a data importing device connected with the network camera and used for importing camera data of the network camera; a segmenting and storing device connected with the data importing device and used for segmenting the imported camera data into a plurality of time segmented data items based on time intervals as well as storing , said plurality of time segmented data items respectively to a plurality of servers and/or to a plurality of server storage areas having non-sequential storage addresses with each other via a network; and a data capture device connected with the servers and/or the server storage areas and used for capturing, according to a search condition, a corresponding time segmented data item and/or a fragment of said corresponding time segmented data item from said plurality of time segmented data items stored in the servers and/or the server storage areas.

According to an embodiment of the present invention, said plurality of time segmented data items have substantially the same time of duration.

According to an embodiment of the present invention, the network camera data management system further comprises a data combination device connected with the data capture device and used for combining the captured time segmented data item and/or the captured fragment thereof into a continuous-time camera data item.

According to an embodiment of the present invention, the retrieval condition is a point of time, an image content, or an audio content.

Further, the present invention also provides a network camera data management method for managing camera data of a network camera, comprising the steps of: (a) importing the camera data of the network camera; (b) segmenting the imported camera data into a plurality of time segmented data items based on time intervals, and storing, via a network, the plurality of time segmented data items respectively in a plurality of servers and/or a plurality of server storage areas having non-sequential addresses with each other; and (c) capturing, according to a search condition, a corresponding time segmented data item and/or a fragment of said corresponding data item from said plurality of time segmented data items stored in said plurality of servers and/or said plurality of server storage areas.

According to an embodiment of the present invention, in the step (a), camera data of the network camera is synchronously imported while the network camera is recording.

According to an embodiment of the present invention, in the step (b), the introduced camera data is segmented into a plurality of time segmented data items based on an equal time interval.

According to an embodiment of the present invention, the network camera data management method further comprises, after a step (c), a step (d) of: combining the captured time segmented data item and/or the captured fragment thereof into a continuous-time camera data item.

By means of technical means of the present invention, the huge-sized camera data can be segmented into a plurality of appropriate-sized data items and thereby can be stored separately in servers and/or server storage areas independent of each other located in one server. Efficient use of space is thus achieved. Further, by means of data miniaturization and distributed storage, subsequent processing of camera data can be performed by multiple server systems, effectively enhancing the system's performance of execution as a whole. Camera data management is implemented at a faster speed and with a better quality.

### BRIEF DESCRIPTION OF THE DRAWINGS

The structure and the technical means adopted by the present invention to achieve the above and other objects can be best understood by referring to the following detailed description of the preferred embodiments and the accompanying drawings.

FIG. 1 is a block diagram illustrating a network camera data management system according to an embodiment of the present invention;

FIG. 2 is a flowchart diagram illustrating a network camera data management method according to an embodiment of the present invention; and

FIG. 3 is a schematic diagram illustrating segmenting and combining a camera data by means of the network camera data management method according to an embodiment of the present invention.

### DETAILED DESCRIPTION OF THE PREFERRED EMBODIMENTS

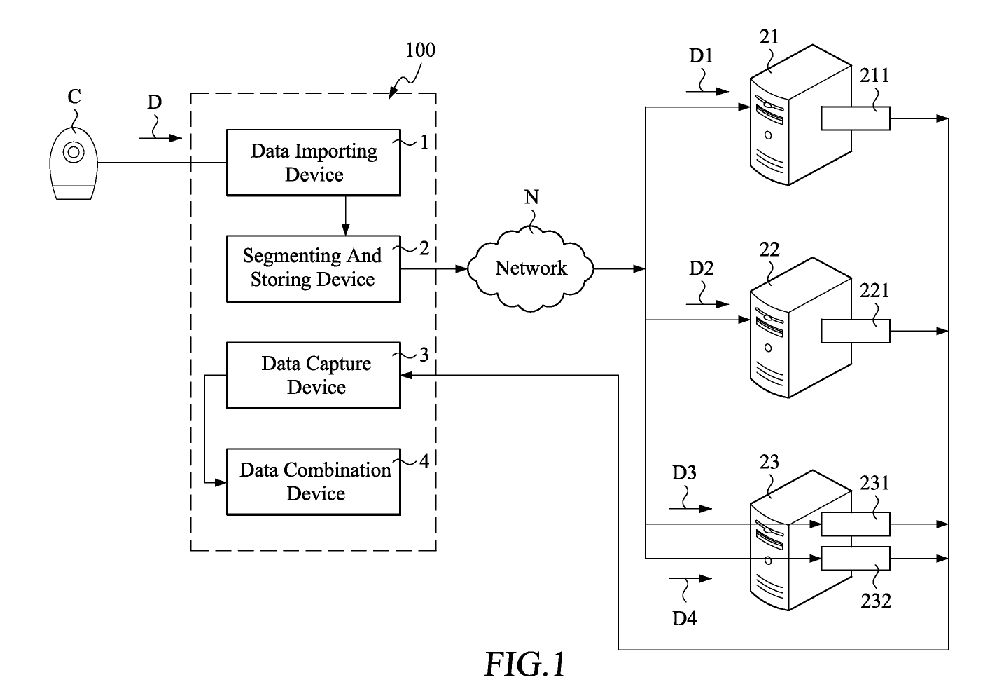

Embodiments are described in detail below with reference to the FIG. 1 to FIG. 3, and the description is used for explaining the embodiments of the present invention only but not for limiting the scope of the claims.

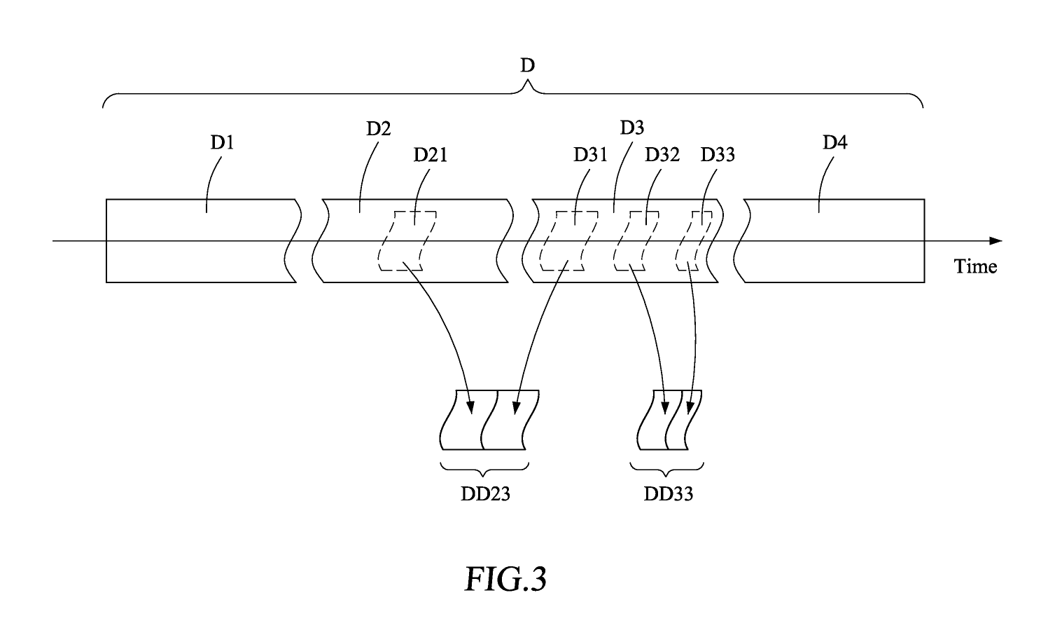

As shown in FIG. 1 and FIG. 3, a network camera data management system 100 according to an embodiment of the present invention is for managing camera data D of a network camera C. The network camera data management system 100 comprises: a data importing device 1 connected with the network camera C and used for importing the camera data D of the network camera C; a segmenting and storing device 2 connected with the data importing device land used for segmenting the imported camera data D into a plurality of time segmented data items D1, D2, D3, and D4 based on time intervals, and storing, via a network N, the plurality of time segmented data items D1, D2, D3, and D4 respectively in a plurality of servers 21, 22, and 23 and/or to a plurality of server storage areas 231 and 232 that have non-sequential storage addresses with each other; and a data capture device 3 connected with the servers 21, 22, and 23 and/or the server storage areas 231 and 232 and used for capturing, according to a search condition, a corresponding time segmented data item and/or a fragment of the corresponding time segmented data item from the plurality of time segmented data items D1, D2, D3, and D4 stored in the servers 21, 22, and 23 and/or the server storage areas 231 and 232.

In the network camera data management system 100, the data importing device 1 and the segmenting and storing device 2 can be provided as built-in parts of the network camera C. However, the present invention is not limited to this. In other embodiments, the data introducing device 1 and the segmenting and storing device 2 can be connected to the network camera C externally. Moreover, in the embodiment shown in FIG. 1, the network camera data management system 100 further includes a data combination device 4 connected with the data capture device 3 and used for combining the captured time segmented data item and/or the captured fragment thereof into a continuous-time camera data item.

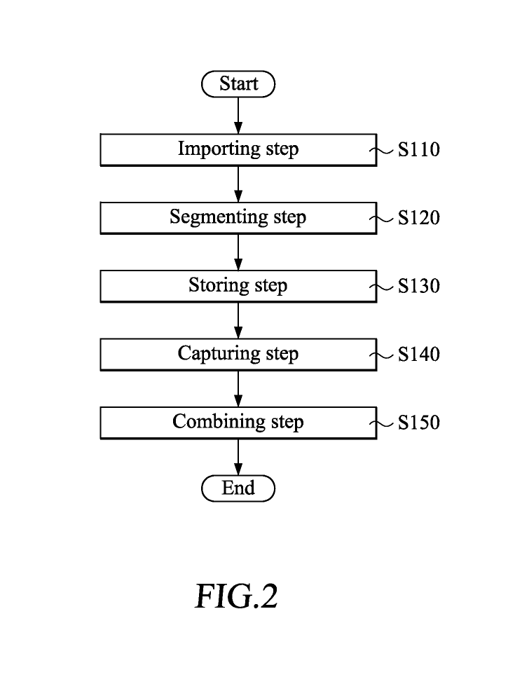

Next, as shown in FIG. 2, a network camera data management method according to an embodiment of the present invention will be described with reference to FIGS. 1 and 3.

Firstly, camera data D of a network camera C is imported by the data introducing device 1 (step S110). Preferably, the camera data D of the network camera C is synchronously imported while the network camera C is recording so as to prevent the camera data D from hoarding at the network camera side that leads to insufficient storage space and low efficiency.

Next, the imported camera data D is transmitted from the data importing device 1 to the segmenting and storing device 2, and then is segmented into a plurality of time segmented data items D1, D2, D3, and D4 based on time intervals (step S120).

There are various ways to segment the data based on time intervals. Generally, the segmenting and storing device 2 can segment the imported camera data D into a plurality of time segmented data items D1, D2, D3, and D4 based on an equal time interval, that is, the plurality of time segmented data items D1, D2, D3, and D4 will have substantially have the same time of duration. Alternatively, the segmenting and storing device 2 can segment, based on time intervals, the imported camera data D into the plurality of time segmented data items D1, D2, D3, and D4 with appropriate data size fitting into the storage areas to be stored therein subsequently. Preferably, the segmenting device 2 can be synchronously segment the camera data D while it is imported without waiting for the camera data D to be completely imported, thereby saving the temporary space effectively.

Next, the plurality of time segmented data items D1, D2, D3, and D4 are transmitted from the segmenting and storing device 2 via a wired/wireless network N to the plurality of servers 21, 22, and 23 and/or to the plurality of server storage areas 231 and 232 that have non-sequential addresses with each other located in one server (step S130). In other words, the plurality of time segmented data items D1, D2, D3, and D4 are stored respectively in different storage areas instead of the same storage area. For example, when the time segmented data item D1 is stored in a server storage area 211 of the server 21, another time segmented item D2 can be stored in a server storage area 221 of the different server 22. Another example, when the time segmented data item D3 is stored in the server storage area 231 of the server 23, another time segmented data item D4 can be stored in the different server storage area 232 of the same server 23. By such storing manner, the data items can be distributed to multiple storage spaces so as to achieve efficient use of space and reduce load of a single server/storage space, and thereby effectively improving the data management efficiency.

Next, when a use feels the need to search, a search condition may be inputted to have the corresponding time segmented data items D1, D2, D3, and D4 and/or corresponding fragments D21, D31, D32, and D33 of the corresponding time segmented data items D1, D2, D3, and D4 captured by the data capture device 3 from the plurality of time segmented data items D1, D2, D3, and D4 stored in the plurality of servers 21, 22, and 23 and/or the plurality of server storage areas 231, 232 (step S140.) The search condition can be a point of time, an image content, or an audio content of the camera data D. For example, for an event happening in a time point, a person, an object, or a motion, and dialogue, sound, or background noise that may appear in the event can be used as a search condition for searching a specific event. According to the search condition, the data capture device 3 performs the search via the plurality of servers 21, 22, and 23. The result can be an entire time segmented data item or can be a fragment of the time segmented data item, i.e., a portion of the time segmented data item. Since the search process can be preferably executed by/shared with respective servers, the processing speed can be significantly improved.

Furthermore, after the data capturing process, the captured time segmented camera data item and/or the captured fragment of the time segmented data item can be combined by the data combination device 4 to form a continuous-time camera data item.

For example, as shown in FIG. 3, the fragments D21 and D31 of the different time segmented data items D2 and D3 can be combined by the data combination device 4 to form a continuous-time camera data item DD23, and the different fragments D32 and D33 of the same time segmented camera data item D3 can be combined by the data combination device 4 to form a continuous-time camera data item DD33. Therefore, search results of fragmented items can be combined for the convenience of the user to observe and edit.

The above description should be considered as only the discussion of the preferred embodiments of the present invention. However, a person with an ordinary skill in the art may make various modifications to the present invention. Those modifications still fall within the spirit and scope defined by the appended claims.

What is claimed is:

1. A network camera data management system for managing camera data of a network camera, comprising:
a data importing device which is connected with the network camera and for importing the camera data of the network camera;
a segmenting and storing device which is connected with the data importing device and for segmenting the imported camera data into a plurality of time segmented data items based on time intervals, and storing, via a network, the plurality of time segmented data items respectively in a plurality of servers and/or in a plurality of server storage areas having non-sequential storage addresses with each other located in one server; and
a data capture device which is connected with the servers and/or the server storage areas and for capturing, according to a search condition, a corresponding time segmented data item and/or a fragment of the corresponding time segmented data item from the plurality of time segmented data items stored in the servers and/or the server storage areas.

2. The network camera data management system as claimed in claim 1, wherein the plurality of time segmented data items have substantially the same time of duration.

3. The network camera data management system as claimed in claim 1, further comprising a data combination device connected with the data capture device used for combining the captured time segmented data item and/or the captured fragment thereof into a continuous-time camera data item.

4. The network camera data management system as claimed in claim 1, wherein the search condition is a point of time, an image content, or an audio content.

5. A network camera data management method for managing camera data of a network camera, comprising the steps of:
(a) importing the camera data of the network camera;
(b) segmenting the imported camera data into a plurality of time segmented data items based on time intervals, and storing, via a network, the plurality of time segmented data items respectively in a plurality of servers and/or a plurality of server storage areas having non-sequential storage addresses with each other located in one server; and
(c) capturing, according to a search condition, a corresponding time segmented data item and/or a fragment of the corresponding time segmented data item from the plurality of time segmented data items stored in said plurality of servers and/or said plurality of server storage areas.

6. The network camera data management method as claimed in claim 5, wherein in the step (a), the camera data of the network camera is synchronously imported while the network camera is recording.

7. The network camera data management method as claimed in claim 5, wherein in the step (b), the imported camera data is segmented into a plurality of time segmented data items based on an equal time interval.

8. The network camera data management method as claimed in claim 5, further comprising, after the step (c), a step (d) of:
combining the captured time segmented data item and/or the captured fragment thereof into a continuous-time camera data item.
